(19) United States
(12) Patent Application Publication
(10) Pub. No.: US 2007/0163704 A1
(43) Pub. Date: Jul. 19, 2007

(54) Method for manufacturing a label comprising a transponder

(75) Inventors: Juuso Jarvinen, Tampere (FI); Jukka Arkilahti, Tampere (FI); Tommi Rutanen, Nokia (FI); Antti Rauhala, Tampere (FI)

Correspondence Address: VENABLE LLP, P.O. BOX 34385, WASHINGTON, DC, 20043-9998, US

(73) Assignee: UPM Rafsec Oy, TAMPERE (FI)

(21) Appl. No.: 11/333,234

(22) Filed: Jan. 18, 2006

(51) Int. Cl. B65C 9/18; G08B 13/14

(52) U.S. Cl. 156/238; 340/572.8

(57) ABSTRACT

The present invention relates to a method for manufacturing a label comprising a transponder on an integrated process line. The transponder comprises an antenna and an integrated circuit on a chip.

### TECHNICAL FIELD

The subject matter of this disclosure relates to a method for manufacturing a label comprising a transponder.

### BACKGROUND ART

Publication US 2003/0121986 discloses a method in which integrated circuits are attached on a production line in a continuous manner to smart labels on a smart label web before a surface web, the smart label web and a back web are attached to each other on the same production line.

### SUMMARY OF THE SUBJECT MATTER

It is an object of the subject matter described in this application to introduce a method for manufacturing a label comprising a transponder on an integrated process line.

In the method all the process steps are taken on the integrated process line. In this application, the integrated process line means that all the process steps are integrated into the same process line so that the materials are processed in a web form and the ready web is reeled up at the end of the integrated process line. However, the process may include steps wherein a web is cut into pieces, but also in those steps the process continues by using manufacturing in a web form.

The process on the integrated process line usually starts with unwinding a web from a roll. The web can be a web onto which antennas are intended to be formed, or it may be a ready antenna web. If it is the ready antenna web then the antennas are formed on a separate process line.

The process on the integrated process line usually ends with reeling up a web. The web can be a label web with printed labels, or a label web with blank labels. If the web is with blank labels the label web will be printed on a separate process line.

The product obtained from the process is the label comprising a transponder. RFID (radio frequency identification) transponder refers to a product which comprises a radio frequency identification circuit which is an electric oscillating circuit (RCL circuit) and is tuned to operate at a defined frequency. The circuit comprises an integrated circuit on a chip, a capacitor and an antenna. The antenna is formed on a substrate which is preferably an organic substrate, such as a plastic or paper substrate. The chip can be a silicon chip, or a polymer chip. The integrated circuit comprises an escort memory and an RF part which communicates with a reader device. The capacitor of the RCL circuit can also be integrated on the chip, but it is possible that the capacitor is formed outside the chip. The antenna can be a coil antenna, or an antenna based on the dipole antenna technique, or an antenna based on some other planar antenna technique. The chip is electrically connected to the antenna, and it can be attached to the antenna either directly or via a module part which comprises the chip and required electrical contacts. The term “electrically connected” also covers capacitive connections.

The antennas are formed on an antenna web. The antenna web must tolerate for example the manufacturing steps of the antenna patterns and the attachment of the chip. The manufacturing steps of the antenna patterns may require resistance to chemicals, and the attachment of the chip often requires heat resistance. Suitable materials for the antenna web include polyester, biaxially orientated polypropylene, or polycarbonate. Also many other materials are available for the antenna web, provided that the material is sufficiently resistant to heat and chemicals.

The antenna is preferably made of aluminium, copper, silver, or a conductive polymeric material, and it is formed on the substrate for example by etching, printing, electrolysis, plating, or by some other additive techniques. It is also possible that the antenna is manufactured on a first substrate and when it is ready it is transferred to a second substrate which is the antenna web.

The above-mentioned manufacturing method can be, for example, such that an antenna pattern is printed on the first substrate by using a paste that comprises metal oxide. The metal oxide is then heated so that the metal oxide is reduced to metal. After that, the metallic antenna pattern is transferred to a flexible web, and by transferring one pattern after another the antenna web is formed. The antenna pattern or the web is provided with an adhesive which glues the antenna and the web together.

The antenna web can be manufactured on a separate process line, after which it is brought to the integrated process line. It is also possible that the antennas are formed onto the web on the integrated process line. In that case, additive antenna manufacturing methods are preferred.

One integrated circuit on the chip is attached per one antenna on the antenna web on the integrated process line. There are many techniques available for attaching the chip to the antenna. The chip can be attached with or without an underfill. The chip can be attached by a solder bump with or without the underfill. A solder bump made of a soldering paste can be attached without the underfill. A metallic solder bump, such as a bump of gold or a mixture of gold and nickel, can be attached with the underfill. As the underfill, it is possible to use an isotropically conductive adhesive, a non-conductive adhesive or an anisotropically conductive adhesive. The above-mentioned adhesives can be dispensed in liquid form, and after dispensing, they are dried and hardened. Usually, the liquid adhesives are dispensed with a capillary underfill technique, i.e. the liquid adhesive is dispensed at a side of the chip, and the adhesive is sucked under the chip by capillary forces. It is also possible that an isotropically conductive adhesive or an anisotropically conductive adhesive is used for achieving an electrical contact, but those adhesives are surrounded by a non-conductive adhesive.

Besides the adhesives in the liquid form, also films can be used as the underfill. The films may be curable or thermoplastic. Anisotropically conductive thermoplastic adhesive films may be used as the underfill, and at the same time they are capable of connecting the chip electrically to the antenna. Also non-conductive thermoplastic films can serve as the underfill, but the electrical connection between the antenna and the chip must be formed with the electrically conductive bumps. The anisotropically conductive adhesive films and non-conductive adhesive films can also be used for attaching the module to its substrate.

Besides the techniques in which the bare chip is attached to the antenna so that an electrical contact is formed between the chip and the antenna, it is possible that the chip is first attached to a module part and the module part is then attached to the antenna. The module part comprises a substrate which is preferably made of a plastic material, such as polyester, biaxially orientated polypropylene, or polyimide. Normally, the substrate is a rectangular strip having the chip in the middle of the strip. The strip has two ends which are provided with contact points which may be electrically conductive bumps. The contact points are connected to the chip via electrically conductive leads which may be formed by the same techniques as the antenna. The contact points are connected with the contact points of the antenna so that the electrical contact between the chip and the antenna is formed. The contact points may consist of bumps. Instead of bumps, it is possible to use capacitor plates which are formed at the ends of the module. The capacitor plates of the module are aligned with capacitor plates which are electrically connected to the antenna and are attached to them in such a manner that an electrically insulating layer remains between the capacitor plates. Thus the electrical connection is formed through the capacitor plates. It is also possible that the capacitor plate is provided at only one end of the module, and the other end has a direct electrical contact formed, for example, by the bumps. The module part may be attached to the substrate comprising the antenna so that it is attached to the same side of the substrate where the antenna is, or it is attached to the reverse side. The module part is usually attached so that the side comprising the chip is in contact with the substrate comprising the antenna.

When the chip is attached to the antenna the formed transponder web is led to a buffer from which it is led to a lamination process. The buffer is required on the integrated process line because the speed of the chip attachment and the speed of lamination differ from each other. The speed of lamination is higher than that of the chip attachment; The speed of the lamination may be even 10 to 20 times higher than the speed of the chip attachment. In principle, the chip attachment is intended to be continuous so that the buffer is filled all the time but the lamination process can be stopped for certain periods of time. The chip attachment may require that the process line stops for a while for each attachment and the web then continues to advance, i.e. the web does not advance at a constant speed. The buffer has a certain degree of filling which is non-constant but depends on the efficiency of the chip attachment and the efficiency of the lamination process. The degree of filling is constantly checked in order to adjust the lamination speed. When the buffer is becoming empty due to too high a lamination speed, the speed is slowed down, i.e. the lamination speed may be variable. When the buffer becomes full, it is possible to speed up the lamination process.

The system for checking the degree of filling is automatic, and its technique may be based on a system comprising an array of rolls, which some are stationary and some are pulled down by gravity. The system can store a certain length of the transponder web. The movable rolls, which are pulled down by the gravity, are at their lowest position when the buffer reaches its maximum capacity. When the buffer becomes empty, the movable rolls move upwards. At least one position sensor monitors the movable rolls in order to determine the degree of filling by software. After the buffer there may be a pulling and braking unit which comprises means for adjusting the tension of the web in the process steps after the buffer. The means for adjusting the tension of the web may comprise two rolls forming a nip. The transponder web travels through the nip in such a manner that it is impossible for the web to slide through the nip. Thus, the web tension can be adjusted and kept on a certain level on the integrated process line following the buffer. In addition to the above-mentioned system there are also other ways of arranging the buffer.

In order to cover and protect the antenna and the chip, a cover web is attached to the transponder web. The cover web is usually made of polyethylene, polypropylene, polyvinyl chloride (PVC), acrylonitrile/butadiene/styrene copolymer (ABS), or polycarbonate. The cover web and the transponder web are attached to each other by an adhesive. The adhesive may be a thermoplastic adhesive, such as a hot melt adhesive, or a settable adhesive, i.e. the adhesive is curable for example by heat, ultraviolet radiation (UV), microwave radiation, or by a treatment with electron beams (EB). The adhesive may be transfer laminated or the adhesive may be applied directly on a web. Depending on the use of the transponder, it is possible that instead of only one cover web there are more than one cover webs covering the antenna and the chip on the transponder web. The cover web may also be a bi-layered or multi-layered film. In certain applications it is possible that the cover web is totally omitted.

The cover web is attached to the transponder web preferably at the same time when a release web is attached to the opposite side of the transponder web. After the cover web and the release web have been attached to the transponder web, the obtained web is cut in a die-cut station into individual transponders so that only the release web remains continuous. A trash web which surrounds the individual labels is removed.

In the following process step, a label web is attached to the release web in such a manner that the transponders on the surface of the release web come into contact with the back side of the label web. The back side of the label web is covered with an adhesive, and the front side of the label web forms a printing substrate. The material of the label web is usually paper, especially of label paper quality. Also plastic materials are possible.

The label web and the release web are laminated together by running them through rollers, which press the two layers together. The resulting laminate is converted further on the integrated process line so that it is at least cut into individual labels, each comprising a transponder. The individual labels are on the surface of the release web.

The laminate is further converted on a printing machine, which prints the labels. It is possible that the web is die-cut into labels after printing. The printing method is determined by the characteristics required by the text and/or figures of the label, and by the application of the product. After proper printing, the label may be post-printed to add e.g. a bar code for product and price information etc.

The integrated process line may comprise more devices than those described above. The integrated process line usually comprises a testing unit to test the functioning of the transponders. The testing unit can be located after the pulling and braking unit before any web is attached to the transponder web, or it can be after the die-cut station where the transponder web is cut into individual transponders. It is possible that the non-functioning transponders are only marked, or they are removed in a separating unit following the testing unit.

The integrated process line may also comprise a slitting unit for cutting the transponder web narrower. The slitting unit may be located after the pulling and braking unit.

The integrated process line is also built such that it is easy to pass a process step if the particular product does not require that step.

### BRIEF DESCRIPTION OF THE DRAWINGS

In the following, the invention will be described with reference to the appended drawings in which

FIGS. 1-3 show transponders in front views,

FIG. 4 shows a label comprising a transponder in a perspective view,

FIG. 5 shows joints used in connection with transponders in cross-sectional views, and

FIGS. 6-10 show integrated process lines or parts of them in schematic side views.

### DETAILED DESCRIPTION

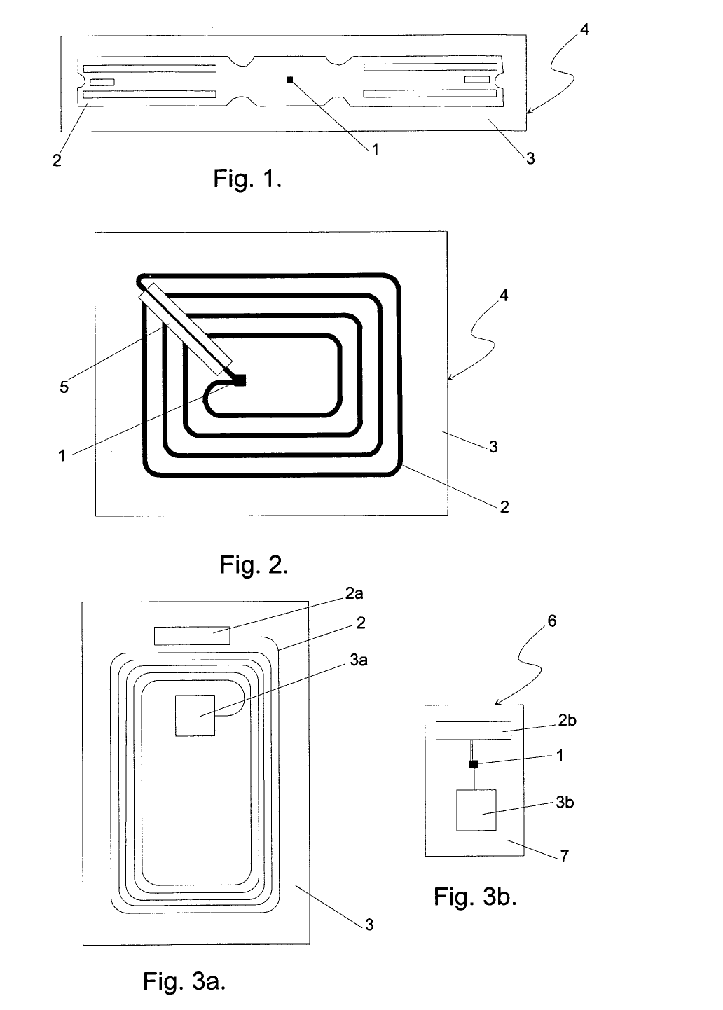

FIG. 1 shows a transponder 4. The transponder 4 comprises a substrate 3 onto which an antenna 2 is formed. An integrated circuit on a chip 1 is electrically connected to the antenna. The antenna 2 of FIG. 1 is an antenna based on the dipole antenna technique, and it antenna works at ultra high frequencies (UHF).

FIG. 2 shows a transponder 4. The transponder 4 comprises a substrate 3 onto which an antenna 2 is formed. An integrated circuit on a chip 1 is electrically connected to the antenna. The antenna 2 of FIG. 2 is a coil. An electrically insulating paste 5 is applied on the antenna in order to prevent short-circuiting.

FIGS. 3a and 3b show parts of a transponder. An antenna 2, a first capacitor plate 2a and a second capacitor plate 3a are placed on a substrate 3. The antenna 2, the first capacitor plate 2a and the second capacitor plate 3a may be formed by flexographic printing and electrolysis on the substrate 3. The antenna 2, the first capacitor plate 2a and the second capacitor plate 3a may be made of aluminium or copper. FIG. 3b shows a module part 6. An integrated circuit on a chip 1, a first capacitor plate 2b and a second capacitor plate 3b are placed on a module substrate 7. The first capacitor plate 2b and the second capacitor plate 3b may be made of aluminium, copper or silver paste.

The module part 6 is attached to the substrate 3 so that the first capacitor plates 2a and 2b and the second capacitor plates 3a and 3b are substantially aligned, respectively. The first capacitor plates form a first capacitor and the second capacitor plates form a second capacitor. The capacitors are connected in series. The capacitors connect the chip 1 to the antenna.

Besides the configuration in FIGS. 3a and 3b, the substrate 3 and the module substrate can be formed without the capacitor plates. In such a case, the electrical connection between the chip 1 and the antenna 2 is formed by connecting the contact points of the module part 7 and the contact points of the antenna 2.

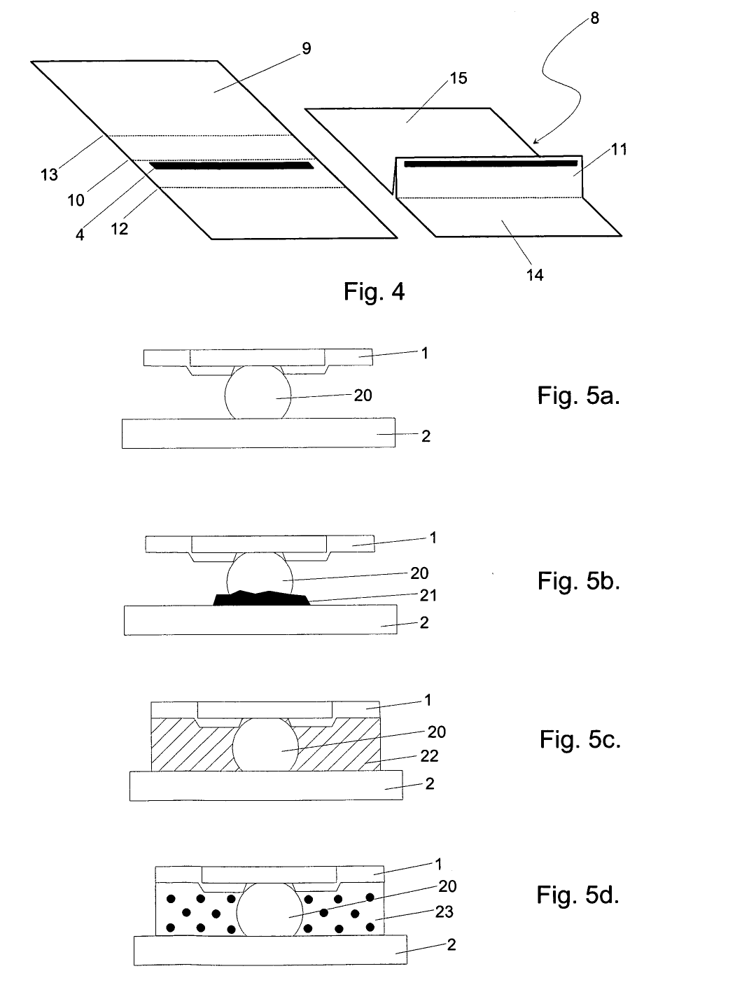

FIG. 4 shows perspective views of a label 8 comprising a transponder 4. The label 8 has a face side 9 which can be used as a printing substrate, and a reverse side (not shown) which is provided with adhesive. The adhesive is preferably a pressure sensitive adhesive, but also other adhesives are possible.

A transponder 4 comprising a substrate and an antenna and a chip on the surface of the substrate is dispensed to the close proximity of a line 10. The label 8 is folded along the line 10 in such a manner that the reverse sides of the label on both sides of the line 10 adhere to each other, and thus a flap 11 is formed comprising the area between the lines 12 and 13. According to FIG. 4, the label 8 has two areas 14 and 15 which can serve as printing substrates, and which have adhesive on their reverse side.

FIGS. 5a to 5d show possible techniques for the attachment of an integrated circuit 1 to an antenna 2. FIG. 5a shows a solder bump 20, by which the integrated circuit on the chip 1 is attached to the antenna 2. The solder bump 20 is made of a soldering paste.

FIG. 5b shows a joint in which an isotropically conductive adhesive 21 is attached to the antenna 2. A solder bump 20, which can be made of gold or a mixture of gold and nickel, is attached to the isotropically conductive adhesive. The solder bump 20 is provided with the integrated circuit on the chip 1.

FIG. 5c shows a joint, in which a solder bump 20 is attached between the antenna 2 and the integrated circuit on the chip 1 and is encapsulated by a non-conductive adhesive 22.

FIG. 5d shows a joint, in which a solder bump 20 is attached between the antenna 2 and the integrated circuit on the chip 1 and is encapsulated by an anisotropically conductive adhesive 23.

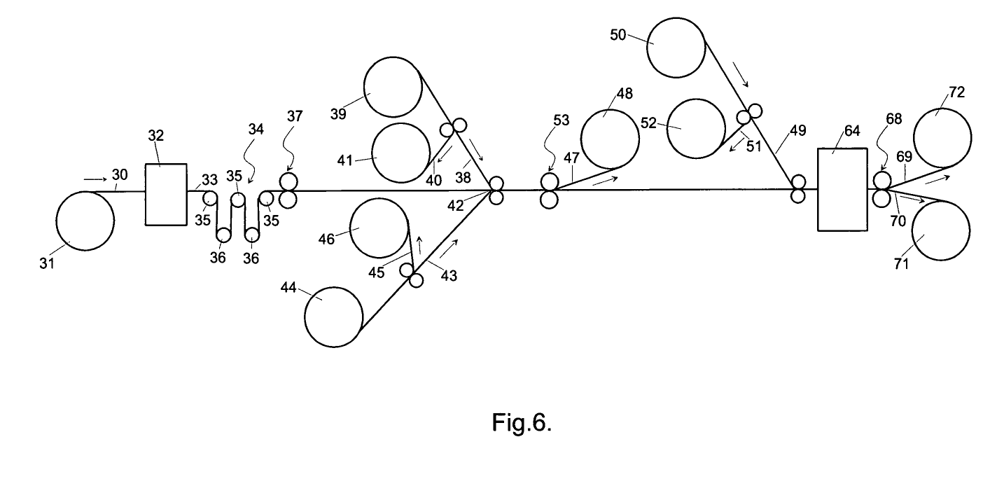

FIG. 6 shows an integrated process line. An antenna web 30 comprising successive antennas is unwound from a roll 31. The antenna web 30 is led to a chip attachment unit 32 in order to attach the chip to the antenna. The chip attachment unit 32 may comprise several successive sub-units for the attachment of the chip, for example a sub-unit for forming a solder bump and a sub-unit for curing an adhesive forming an underfill. When the antennas of the antenna web 30 are provided with the chips (each antenna with one chip), a transponder web 33 is formed. The transponder web 33 is led to a buffer 34. The buffer 34 has a certain non-constant degree of filling which can be controlled. There are fixed rolls 35 and movable rolls 36 in the buffer 34. The movable rolls 36 are pulled down by gravity when the buffer 34 is filled with the transponder web 33. When the buffer 34 becomes empty, the movable rolls move upwards. At least one sensor (not shown in FIG. 6) monitors the position of the movable rolls 36. The degree of filling can be calculated from the output of the sensor. The speed of the lamination line after the buffer 34 is adjusted according to the degree of filling.

After the buffer there may be a pulling and braking unit 37 which comprises means for adjusting the tension of the web in the process steps after the buffer 34. The means for adjusting the tension of the web may comprise two rolls forming a nip. The transponder web travels through the nip in such a manner that it is impossible for the web to slide through the nip. Thus the web tension can be adjusted and kept at a certain level on the integrated process line following the buffer 34.

After the buffer 34 and the possible pulling and braking unit 37 a cover web 38 provided with an adhesive is unwound from a roll 39. A release liner 40 protecting the adhesive is reeled up to a roll 41. A release web 43 provided with an adhesive is unwound from a roll 44. A release liner 45 protecting the adhesive is reeled up to a roll 46. The transponder web 33, the cover web 38 and the release web 43 are attached together in a nip 42. Naturally the cover web 38 and the release web 43 can be transposed. After that the formed web is die-cut and/or slit on a first die-cut station 53 in such a manner that only the release web 43 remains untouched. The die-cut station 53 can make the cutting operation from the upper side as described above, or it can make the cutting operation from underneath. When a trash web 47 is stripped off and wound to a roll 48, individual transponders 4 remain on the surface of the release web 43. A label web 49 provided with an adhesive is unwound from a roll 50. A release liner 51 protecting the adhesive is reeled up to a roll 52. The label web is attached to the release web 43 comprising individual transponders 4 on its surface. After that, the resulting web is led to a printing unit 64 which prints the labels which have not yet been cut into individual labels. The web is cut into individual labels on a second die-cut station which may be similar to the first die-cut station 53. A web 70 comprising ready printed labels on the surface of the release web 43 is wound onto a roll 71 and a trash web 69 is wound onto a roll 72.

The first die-cut station 53 may be followed by a unit (not shown) for making a register mark. It is noteworthy that one register mark can be utilized throughout the process.

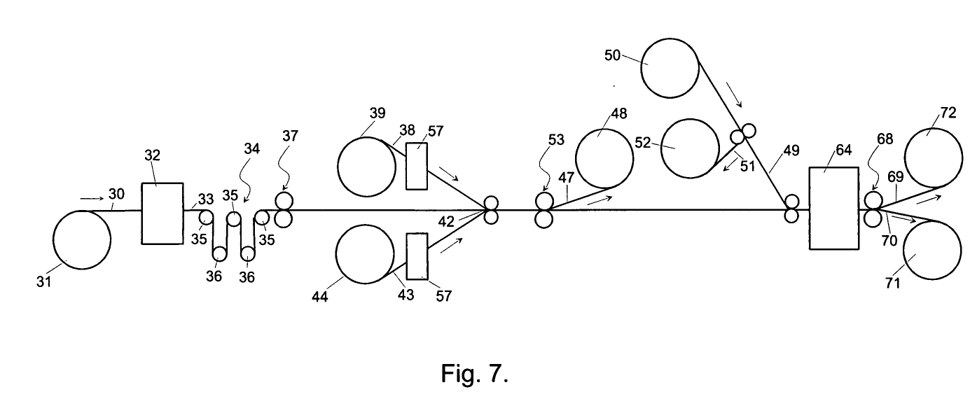

FIG. 7 shows an integrated process line. The integrated process line of FIG. 7 is the same as in FIG. 6 except that there is a hot melt unit 57 for applying a hot melt adhesive between the transponder web 33 and the cover web 38, and between the transponder web 33 and the release web 43. In that case the release liners 40, 45 are not required. Usually the hot melt adhesive is applied on that side of the cover web 38 and the release web 43 which comes into contact with the transponder web 33, but it is also possible that the hot melt adhesive is applied on both sides of the transponder web 33. It is also possible that either the cover web 38 or the release web is attached to the transponder web by the hot melt adhesive, and the other web is attached by the method shown in FIG. 6.

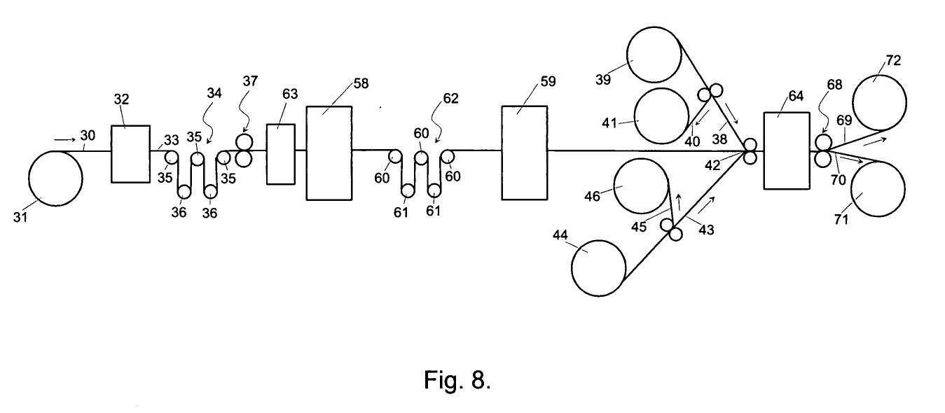

FIG. 8 shows an integrated process line. The integrated process line of FIG. 8 is the same as in FIG. 6 except that there are additional processing units between the pulling and braking unit 37 and the nip 42. The integrated process line can be as shown in FIG. 1 after the nip 42. A slitting unit 63, a testing unit 58, a buffer 62 and a separating unit 59 are provided between the pulling and braking unit 37 and the nip 42. The slitting unit 63 is used for slitting the transponder web 33 if it is too wide and it should be narrowed. In the testing unit 58, each transponder is tested to find out whether the transponder functions properly. If the test result is negative, i.e. the transponder does not function properly, it is removed in the separating unit 59 so that only properly functioning transponders are allowed to move towards the nip 42. In practice, the non-functioning transponders may be removed by cutting the transponder web 33 in two and joining the ends of the web 33 together by heat-sealing after the non-functioning transponder has been removed. Following the testing unit 58 there is a buffer 62 which may function in the same way as described in connection with the buffer 34, i.e. there are stationary rolls 60 and movable rolls 61. The buffer 62 is used for levelling the speed differences before and after the buffer 62.

Another possibility for arranging the testing unit 58 and the separating unit 59 is to place them after the die-cut station 53 where separate transponders can be removed individually from the release web 43.

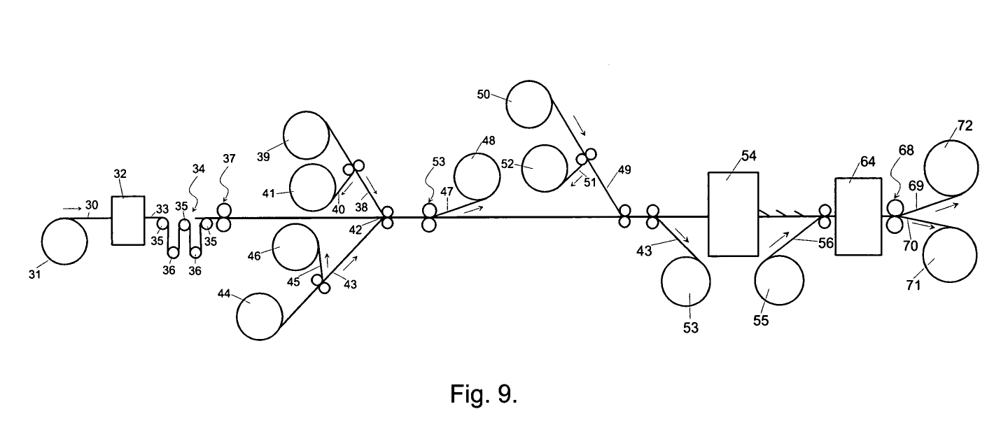

FIG. 9 shows an integrated process line. The integrated process line of FIG. 9 is the same as in FIG. 6 except that there is a folding unit 54 which is arranged to make folds in the label web 49. The transponders 4 remain inside the folds as explained in connection with FIG. 4. In order to fold the label web 49, the release web 43 must be reeled up onto a roll 53. After the folding unit another release web 56 is unwound from a roll 55 and attached to the label web 49. The rest of the process line after attaching the release web 56 can be similar to FIG. 6 except that the release web 43 is replaced by the release web 56.

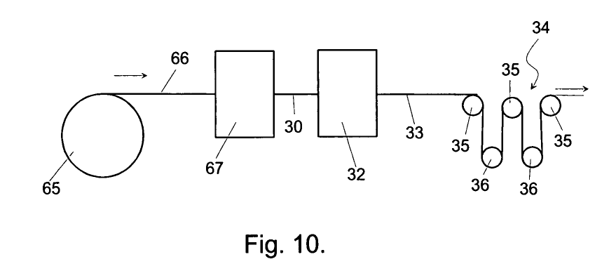

FIG. 10 shows a part of an integrated process line. A web 66 is unwound from a roll 65. The web 66 is led to an antenna forming unit 67 which can be a printer for printing electrically conductive paste on the web 66 in order to form antennas. A ready antenna web 30 leaves the antenna forming unit 67 and enters a chip attachment unit 32. After the chip attachment, a transponder web 33 advances to a buffer 34. The rest of the integrated process line may function as illustrated in FIGS. 6-9. In other words, all the choices described in FIGS. 6-9, or their combinations are available when the beginning of the integrated process line corresponds to FIG. 10.

FIGS. 6-10 show a few integrated process lines or parts of them but it is obvious that also combinations of those process lines are possible. For example, the slitting unit 63, the testing unit 58 and the separating unit 59, which are shown in FIG. 8, may exist on every integrated process line all together or each unit alone. The antenna forming unit 67 of FIG. 10 may exist on the same integrated process line as the printing unit 64 of FIG. 6. The hot melt units 57 of FIG. 7 can be transposed with the process part described in FIGS. 6, 8 and 9. It is possible that the cover web 38 can be omitted and the transponder is attached to the label web 49 so that the antenna 2 contacts the reverse side of the label web.

1. A method for manufacturing a label comprising a transponder on an integrated process line, the transponder comprising an antenna and an integrated circuit on a chip, the method comprising:
providing a antenna web comprising successive antennas on its surface,
placing on the integrated process line an integrated circuit on an antenna of the antenna web so that an electrical contact is formed between the antenna and the integrated circuit, thus forming a transponder web,
feeding the transponder web comprising the successive antennas each provided with a chip, into a buffer which has a certain non-constant degree of filling,
providing a release web for a lamination process,
checking the degree of filling,
adjusting the speed of the lamination process according to the degree of filling,
laminating on the integrated process line the release web onto the transponder web,
cutting the transponder web into individual transponders which are adhesively attached to the surface of the release web,
providing a label web having a front side and a back side which is covered with an adhesive,
laminating on the integrated process line the release web, which has individual transponders on its surface, and the back side of the label web together so that one transponder after another adheres to the back side of the label web, and
cutting the label web on the integrated process line to form individual labels, each provided with a transponder.

2. The method of claim 1, wherein the antenna is formed on the integrated process line before attaching the chip.

3. The method of claim 1, wherein a cover web is laminated to the opposite surface of the transponder web in relation to the release web.

4. The method of claim 1, wherein the labels are printed on the integrated process line.

5. The method of claim 1, wherein the label web is die-cut into individual labels, each comprising a transponder on the integrated process line.

6. The method of claim 1, wherein the label web is folded after dispensing the transponder to the back side of the label web on the integrated process line so that the transponder remains inside the fold.

7. The method of claim 1, wherein the transponder is tested in regard to the functionality before it is attached to the label web.

8. The method of claim 7, wherein the transponder is removed when it is not working properly.

9. A method for manufacturing a label comprising a transponder on an integrated process line, the transponder comprising an antenna and an integrated circuit on a chip, the method comprising:
providing a web,
forming successive antennas on the surface of the web on the integrated process line, thus forming an antenna web,
placing on the integrated process line an integrated circuit on a chip onto an antenna of the antenna web so that an electrical contact is formed between the antenna and the integrated circuit, thus forming a transponder web,
feeding the transponder web comprising the successive antennas each provided with a chip, into a buffer which has a certain non-constant degree of filling,
providing a release web for a lamination process,
checking the degree of filling,
adjusting the speed of the lamination process according to the degree of filling,
laminating on the integrated process line the release web to the transponder web,
cutting the transponder web into individual transponders which are adhesively attached to the surface of the release web,
providing a label web having a front side and a back side which is covered with an adhesive,
laminating on the integrated process line the release web, which has individual transponders on its surface, and the back side of the label web together so that one transponder after another adheres to the back side of the label web, and
cutting the label web on the integrated process line to form individual labels, each provided with a transponder.

10. The method of claim 9, wherein a cover web is laminated to the opposite surface of the transponder web in relation to the release web.

11. The method of claim 9, wherein the labels are printed on the integrated process line.

12. The method of claim 9, wherein after dispensing the transponder to the back side of the label web on the integrated process line, the label web is folded so that the transponder remains inside the fold.

13. The method of claim 9, wherein the transponder is tested in regard to the functionality before it is attached to the label web.

14. The method of claim 13, wherein the transponder is removed when it is not working properly.

15. A method for manufacturing a label comprising a transponder on an integrated process line, the transponder comprising an antenna and an integrated circuit on a chip, the method comprising:
providing a antenna web comprising successive antennas on its surface,
placing on the integrated process line an integrated circuit onto an antenna of the antenna web so that an electrical contact is formed between the antenna and the integrated circuit, thus forming a transponder web,
feeding the transponder web comprising the successive antennas, each provided with a chip, into a buffer which has a certain non-constant degree of filling,
providing a release web for a lamination process,
checking the degree of filling,
adjusting the speed of the lamination process according to the degree of filling,
laminating on the integrated process line the release web to the transponder web,
cutting the transponder web into individual transponders which are adhesively attached to the surface of the release web,
providing a label web having a front side and a back side which is covered with an adhesive, and
laminating on the integrated process line the release web, which has individual transponders on its surface, and the back side of the label web together so that one transponder after another adheres to the back side of the label web,
cutting the label web on the integrated process line to form individual labels, each provided with a transponder, and
printing the labels of the label web on the integrated process line.

16. The method of claim 15, wherein the antenna is formed on the integrated process line before attaching the chip.

17. The method of claim 15, wherein a cover web is laminated to the opposite surface of the transponder web in relation to the release web.

18. The method of claim 15, wherein after dispensing the transponder to the back side of the label web on the integrated process line, the label web is folded so that the transponder remains inside the fold.

19. The method of claim 15, wherein the transponder is tested in regard to the functionality before it is attached to the label web.

20. The method of claim 19, wherein the transponder is removed when it is not working properly.
